(19) United States
(12) Patent Application Publication
(10) Pub. No.: US 2024/0360339 A1
(43) Pub. Date: Oct. 31, 2024

(54) METHOD FOR FORMING A BOND BETWEEN TWO SUBSTRATES OF A DEVICE; DEVICE OBTAINABLE BY THE METHOD; A MICROFLUIDIC DEVICE; AND USE OF THE DEVICE

(71) Applicants: MICRONIT HOLDING B.V., ENSCHEDE (NL); UNIVERSITEIT TWENTE, ENSCHEDE (NL)

(72) Inventors: Jurriaan HÜSKENS, Enschede (NL); Daniele DI IORIO, Osnabrück (DE); Maciej Damian SKOLIMOWSKI, Enschede (NL); Brigitte Bibiche Bruijns, Enschede (NL)

(73) Assignee: MICRONIT HOLDING B.V., ENSCHEDE (NL)

(21) Appl. No.: 18/553,313

(22) PCT Filed: Mar. 21, 2022
(86) PCT No.: PCT/EP2022/057333

§ 371 Date: Sep. 29, 2023

(30) Foreign Application Priority Data
Mar. 30, 2021 (NL) 2027864

(51) Int. Cl. C09J 5/02; B01L 3/00; B32B 7/12; B32B 27/08; B32B 27/32; B32B 37/12

(52) U.S. Cl. CPC C09J 5/02; B01L 3/502707; B01L 3/502761; B32B 7/12; B32B 27/08; B32B 27/325; B32B 37/12; B01L 2200/0647; B01L 2300/0636; B01L 2300/16; B32B 2250/02; B32B 2250/242; B32B 2255/10; B32B 2255/26; C09J 2423/008; C09J 2477/00

(57) ABSTRACT

A method for forming a bond between substrates of a device includes providing first and second substrates, providing a first functionalized polyelectrolyte polymer (A) and providing a second functionalized polyelectrolyte polymer (B). Forming a functionalized surface on an exposed surface of the first substrate having the first functionalized polyelectrolyte polymer (A) attached thereto, forming a functionalized surface on an exposed surface of the second substrate having the second functionalized polyelectrolyte polymer (B) attached thereto, contacting at least a part of the functionalized surface of the first substrate onto at least a part of the functionalized surface of the second substrate thereby forming a contact area between the first functionalized polyelectrolyte polymer (A) and the second functionalized polyelectrolyte polymer (B), and forming a covalent bond between a first coupling moiety (A1) and a second coupling moiety (B1) in the contact area between the first and second substrates for binding the substrates.

### FIELD OF INVENTION

The field of the invention relates to a method for forming a bond between two substrates of a device. The field of the invention further relates to a device obtainable by the method according to the present invention, and uses of the device, in particular a biosensor or a microfluidic device, according to the present invention. The field of the invention further relates to a microfluidic device.

### BACKGROUND

Rigid thermoplastic polymers, as well as flexible thermoplastic-elastic polymers, such as membranes, are widely investigated as innovative materials for the fabrication of lab-on-a-chip and microfluidic devices, as they offer cost effective and high-volume production alternatives to the more traditionally used materials such as glass and silicon. Polycarbonate (PC), poly-(methyl methacrylate) (PMMA), polystyrene (PS), cyclic olefin copolymer (COC), and styrene-ethylene-butylene-styrene (SEBS) have particularly emerged as attractive substrates for this type of applications owing to some beneficial physico-chemical properties. Their high transparency and low autofluorescence enable, for example, the use of widespread and advantageous optical techniques (e.g. fluorescence detection) for biosensing applications. Additionally, other rigid materials such as glass are widely used as materials for the fabrication of lab-on-a-chip and microfluidic devices.

In a typical process for the fabrication of microfluidic devices, open microchannels are initially formed in thermoplastic substrate by means of several techniques, including soft lithography, micro-injection molding, micro-milling, embossing or laser ablation. Subsequently, a second capping layer is bonded to the microchannel modified substrate in order to enclose the channels and seal the entire device and avoid undesired leakage of fluids. To achieve a proper sealing of the substrates, several methods of bonding polymers are used, mainly including thermal bonding or solvent-assisted bonding. Often, bonding temperatures near the glass transition temperatures (T_{g}) of the polymeric substrates need to be used to obtain a proper surface bonding and the sealing of the microchannel.

A desire exists, especially for polymeric substrates, to obtain proper bonding of the substrates and/or sealing of a microchannel contained in a substrate at a relatively low bonding temperature.

Moreover, a desire exists to expand of the functionalities of microfluidic devices, particularly in the use of chemically specific coatings. These coatings are used e.g. to control the wettability (e.g. making chip surfaces hydrophilic), or for molecular sensing when using samples for diagnostic applications. In particular, the possibility to chemically modify a miniaturized biosensing device surface and selectively immobilizing biological molecules (e.g. proteins or antibodies) represent a key feature for the development of new surface coatings. Therefore, a desire is to develop a multi-purpose, biocompatible, environmentally friendly surface modification method that is easily scalable for high-volume manufacturing.

Moreover, a desire exists to provide a method for forming a bond between substrates of a device, such as a microfluidic device, leading to a strong bonding strength between the substrates while bonding at temperature conditions well below a T_{g} of the substrates, preferably using temperature conditions close to room temperature.

### SUMMARY

According to a first aspect of the invention there is provided a method for forming a bond between two substrates of a device, comprising the steps of:
a. providing a first substrate and a second substrate of a device;
b. providing a first functionalized polyelectrolyte polymer A comprising a plurality of electrolyte repeating units, wherein at least one of the electrolyte repeating units is a functionalized repeating unit G1 comprising a first functional group comprising a first coupling moiety A1;
c. providing a second functionalized polyelectrolyte polymer B comprising a plurality of electrolyte repeating units, wherein at least one of the electrolyte repeating units is a functionalized repeating unit G2 comprising a second functional group comprising a second coupling moiety B1:
   wherein the second coupling moiety B1 is selected to be complementary for forming a covalent bond to the first coupling moiety A1 at a temperature below 100° C.;
d. forming a functionalized surface on an exposed surface of the first substrate having the first functionalized polyelectrolyte polymer A attached to said first substrate;
e. forming a functionalized surface on an exposed surface of the second substrate having the second functionalized polyelectrolyte polymer B attached to said second substrate;
f. contacting at least a part of the functionalized surface of the first substrate onto at least a part of the functionalized surface of the second substrate thereby forming a contact area between the first functionalized polyelectrolyte polymer A and the second functionalized polyelectrolyte polymer B; and
g. forming a covalent bond between the first coupling moiety A1 and the second coupling moiety B1 in the contact area between the first substrate and the second substrate for binding the first substrate to the second substrate.

According to another aspect of the invention there is provided a device obtainable by the method according to the invention, wherein the device comprises a first substrate and a second substrate bonded to each other, wherein the first substrate comprises a functionalized surface having the first functionalized polyelectrolyte polymer A attached thereon, wherein the first substrate comprises a functionalized surface having the first functionalized polyelectrolyte polymer A attached thereon, wherein the second substrate comprises a functionalized surface having the second functionalized polyelectrolyte polymer B attached thereon; and wherein the first substrate and a second substrate are bonded to each other at a contact area, which is formed by contacting the first functionalized polyelectrolyte polymer A with the second functionalized polyelectrolyte polymer B; and wherein the first substrate is bonded to the second substrate by covalent bonds formed between first coupling moieties A1 and second coupling moieties B1 in the contact area between the first substrate and the second substrate.

According to another aspect of the invention there is provided a microfluidic device comprising:
a. a first substrate comprising a functionalized surface having the first functionalized polyelectrolyte polymer A attached thereon, wherein the first functionalized polyelectrolyte polymer A comprises electrolyte repeating units, wherein at least one of the electrolyte repeating units is a functionalized repeating unit G1 comprising a first functional group comprising a first coupling moiety A1;
b. a second substrate comprising a functionalized surface having the second functionalized polyelectrolyte polymer B attached thereon, wherein the second functionalized polyelectrolyte polymer B comprises electrolyte repeating units, wherein at least one of the electrolyte repeating units is a functionalized repeating unit G2 comprising a second functional group comprising a second coupling moiety B1;
wherein the first substrate and a second substrate are bonded to each other at a contact area, wherein the first functionalized polyelectrolyte polymer A contacts the second functionalized polyelectrolyte polymer B; and wherein covalent bonds are present between first coupling moieties A1 of the first substrate and second coupling moieties B1 of the second substrate.

According to another aspect of the invention there is provided a use of the device according to the invention for at least one or more of the detection of an analyte, the fabrication or modification of nanoparticles, the formation of droplets, and the synthesizing of chemicals. In particular the device is a biosensor and/or is a microfluidic device.

The functionalized surface of the first substrate comprises a first coupling moiety A1, preferably a plurality of first coupling moiety A1. The functionalized surface of the second substrate comprises a second coupling moiety B1, preferably a plurality of second coupling moiety B1. As the second coupling moiety B1 is selected to be complementary for forming a covalent bond to the first coupling moiety A1 at a temperature below 100° C., the first substrate can be bonded to the second substrate by contacting the functionalized surface of the first substrate to the functionalized surface of the second substrate and allowing first coupling moiety A1 to form a covalent bond with second coupling moiety B1. The covalent bond forming step between the first coupling moiety A1 and the second coupling moiety B1 has the advantage that a low temperature and mild conditions can be used for forming said covalent bonding. By using a plurality of first coupling moiety A1 and a plurality of second coupling moiety B1 a strong bond can be obtained in the contact area at very mild conditions.

In particular embodiments, the bond forming step g. is performed substantially without solvent and/or substantially without a catalyst being present in the contact area between the first substrate and the second substrate. The coupling moieties A1, B1 can form a covalent bond between them at very mild conditions, i.e. without solvent and without catalyst and at low temperatures.

Said low-temperature bonding serves e.g. the purpose of allowing device fabrication using open channels of a device pre-functionalized with biomolecules, followed by bonding with a cover substrate, without damaging the biomolecules. The cover substrate may be a cover slide or may additionally contain channel structures, membranes and/or other functionalities.

The bonding can be obtained at low temperature, such as at room temperature, and solvent free. The bonding process is in particular suitable for bonding thermoplastic components, such as bonding of COC substrates, exploitable for the fabrication and functionalization of microfluidic devices.

In particular, it has surprisingly been found that click-chemistry binding reactions can be effectively used for bonding substrates to one another using the method according to the invention. Click-chemistry binding reactions have been developed to bind specific molecules, such as receptor molecules, to functionalized surfaces of supports. The click-chemistry binding reactions provide mild reaction conditions, such as low temperature reactions, no need of solvents and no need of radiation to initiate or accelerate the covalent bonding reactions.

### (Device)

In an embodiment, the device is a biosensor. The term “biosensor” has its regular scientific meaning throughout the text, and here refers to an analytical device or apparatus, used for the reaction and the detection of an analyte, optional including binding of the analyte, wherein the biosensor combines a biological component with a physicochemical detector. A sensitive bio (chemical) element of the biosensor, e.g. tissue, microorganisms, organelles, cell receptors, enzymes, antibodies, nucleic acids, is a biologically derived material or biomimetic component that recognizes and interacts and binds with the analyte under study. The biologically sensitive elements can also be created by biological engineering. The transducer or the detector element of the biosensor, which transforms one signal into another one, works in a physicochemical way: for example optically, piezo-electrically, electrochemically, applying electro-chemiluminescence, resulting from the interaction of the analyte with the biological element, to facilitate detecting, measuring and/or quantifying the analyte. A biosensor typically consists of a bio-recognition site, typically exposed at the surface of a carrier material or solid support, such as a polymer material, a plastic, glass, gold, a transducer component, such as a bio-transducer component, and an electronic system which may include a signal amplifier, processor, and display. Transducers and electronics can be combined, e.g., in CMOS-based microsensor systems. The recognition component, often called a bioreceptor or a receptor (bio) molecule, uses biomolecules from organisms or receptors modeled after biological systems to interact with the analyte of interest, which biomolecules are bound or adhered to the carrier or support, often via one or more linkers known in the art. This interaction between the receptor biomolecule and the analyte is measured by the bio-transducer which outputs a measurable signal, which may be proportional to the presence of the target analyte in the sample. The general aim of the design of a biosensor is to enable quick, convenient testing often at the point of concern or care where the sample was procured. In a biosensor, the bioreceptor is designed to interact with the specific analyte of interest to produce an effect measurable by the transducer. High selectivity for the analyte among a matrix of other chemical or biological components is a key requirement of the bioreceptor. While the type of biomolecule applied as the receptor biomolecule used can vary widely, biosensors can be classified according to common types of bioreceptor or receptor biomolecule interactions involving amongst others antibody/antigen, enzymes/ligands, nucleic acids/DNA, cellular structures/cells, or biomimetic materials.

In an embodiment, the device is a microfluidic device. In an embodiment, the microfluidic device is a biosensor device.

In an embodiment, the device additionally comprises at least one enclosed space selected from a chamber and a channel. Preferably, a part of functionalized surface of the first substrate is located to be exposed to said enclosed space of the device and/or a part of functionalized surface of the second substrate is located to be exposed to said enclosed space of the device.

In an embodiment, said part of the respective functionalized surface is a receptor area functionalized with functionalized receptor molecules.

The enclosed space, such as a chamber, comprises an inlet and optionally further comprises an outlet.

### (Substrates)

In an embodiment, the exposed surface of the first substrate and/or the exposed surface of the second substrate is the surface of a material selected from the group of materials comprising glass, silicon, silicon oxide, silicon/silicon oxide, titanium oxide, a metal oxide, a polymer material, such as an activated polymer, a cyclic olefin polymer, and a metal, such as copper, in particular a noble metal, such as silver, platinum and gold.

In an embodiment, the exposed surface of the first substrate and/or the exposed surface of the second substrate is the surface of a thermoplastic material, preferably a cyclic olefin (co) polymer.

The substrates are solid substrates. The substrates may be a support structure. Examples of substrates according to the invention are structured substrates having one or more chambers and/or one or more channels, such as open channels, cover plates, capping layers, or any other functional parts of the device.

### (Functionalized Polyelectrolyte Polymer)

The functionalized polyelectrolyte polymers comprise a polyelectrolyte polymer backbone. Polyelectrolytes according to the invention can be linear, branched, or crosslinked polymers or copolymers. Examples include polyethyleneimine, polyionenes, polyaminoalkyl methacrylate, polyvinylpyridine, polylysine, polyacrylic acid, polymethacrylic acid, polysulfonic acid, polyvinyl sulfate, polyacrylamido-2-methyl-1-propanesulfonic acid, poly(allylamine), poly(diethyldiammonium chloride), and polystyrene sulfonic acid.

Preferred polyelectrolytes include polylysine, polyethyleneimine and polyacrylamido-2-methyl-1-propanesulfonic acid. Ionic or ionizable groups may be present in every repeat unit, or only in some repeat units. The molecular weight of polyelectrolytes may be between 5,000 Daltons and one million Daltons.

In an embodiment, the first functionalized polyelectrolyte polymer A is a first poly-cationic polymer A+ having cationic repeating units. In an embodiment, the second functionalized polyelectrolyte polymer B is a second poly-cationic polymer B+ having cationic repeating units.

Exemplary poly-cationic polymers include polyethyleneimine, polylysine, polyaminoalkyl methacrylate, polyvinylpyridine, poly(allylamine), poly(diethyldiammonium chloride), polyquaternium comprising quaternary ammonium groups or any other poly-cationic polymer. In an embodiment, at least one of the first functionalized polyelectrolyte polymer A and the second functionalized polyelectrolyte polymer B comprises a poly-L-lysine (PLL) segment, preferably wherein both functionalized polyelectrolyte polymers A and B comprise a poly-L-lysine (PLL) segment.

Poly-L-lysine (PLL) is a versatile polymer, composed of positively charged lysine amino acids as a repeat unit, which has attractive biochemical properties, including hydrophilicity, excellent biocompatibility and an acceptable degree of biodegradability. Because PLL is positively charged at physiological pH, it can be easily adsorbed on a large variety of negatively charged substrates via electrostatic interactions, including glass, metals, polymers, and metal oxides. Furthermore, PLL polymers are easily modified with nonionic molecules, thereby making it an ideal candidate for engineering surfaces and interfaces.

In an embodiment, at least one of the first functionalized polyelectrolyte polymer A and the second functionalized polyelectrolyte polymer B additionally comprises one or more other electrolyte repeating units other than a L-lysine repeating unit.

In an alternative embodiment, the first functionalized polyelectrolyte polymer A is a first poly-anionic polymer A—having anionic repeating units:

In an alternative embodiment, the second functionalized polyelectrolyte polymer B is a second poly-anionic polymer B—having anionic repeating units.

Exemplary poly-anionic polymers include polyacrylic acid, polymethacrylic acid, polysulfonic acid, polyvinyl sulfate, polyacrylamido-2-methyl-1-propanesulfonic acid, polystyrene sulfonic acid or any other polyacid polymer, and all corresponding poly-anion derivatives resulting from them.

### (Functionalized Repeating Unit)

Preferably, a plurality of the functionalized repeating units G1 of the first functionalized polyelectrolyte polymer A comprises the first functional group comprising the first coupling moiety A1.

In an embodiment, the number-% of functionalized repeating units G1 is in the range of 1% to 50% with respect to all electrolyte repeating units of the first functionalized polyelectrolyte polymer A, preferably the number-% of functionalized repeating units G1 is in the range of 5% to 40%, more preferably the number-% of functionalized repeating units G1 is in the range of 5% to 30%.

Preferably, a plurality of the functionalized repeating units G2 of the second functionalized polyelectrolyte polymer B comprises the second functional group comprising the second coupling moiety B1.

In an embodiment, the number-% of functionalized repeating units G2 is in the range of 1% to 50% with respect to all electrolyte repeating units of the second functionalized polyelectrolyte polymer B, preferably the number-% of functionalized repeating units G2 is in the range of 5% to 40%, more preferably the number-% of functionalized repeating units G2 is in the range of 5% to 30%.

### (Non-Functionalized Repeating Unit)

In an embodiment, the electrolyte repeating units of the first functionalized polyelectrolyte polymer A comprise non-functionalized repeating units E1 having one or more non-functionalized electrolyte groups selected from cationic groups and anionic groups, wherein the number-% of non-functionalized repeating units E1 is in the range of 30% to 99% with respect to all electrolyte repeating units of the first functionalized polyelectrolyte polymer A, preferably the number-% of non-functionalized repeating units E1 is in the range of 50% to 95% with respect to all electrolyte repeating units.

In an embodiment, the electrolyte repeating units of the second functionalized polyelectrolyte polymer B comprise non-functionalized repeating units E2 having one or more non-functionalized electrolyte groups selected from cationic groups and anionic groups, wherein the number-% of non-functionalized repeating units E2 is in the range of 30% to 99% with respect to all electrolyte repeating units of the second functionalized polyelectrolyte polymer B, preferably the number-% of non-functionalized repeating units E2 is in the range of 50% to 95% with respect to all electrolyte repeating units.

### (Linking Group)

In an embodiment, at least a part of the functionalized repeating units G1 of the first functionalized polyelectrolyte polymer A comprises a linking group for bonding the first functional group to the backbone of the corresponding repeating unit, preferably all functionalized repeating units G1 comprise a linking group for bonding the first functional group to the backbone of the corresponding repeating unit.

In an embodiment, at least a part of the functionalized repeating units G2 of the second functionalized polyelectrolyte polymer B comprises a linking group for bonding the second functional group to the backbone of the corresponding repeating unit, preferably all functionalized repeating units G2 comprise a linking group for bonding the second functional group to the backbone of the corresponding repeating unit.

In an embodiment, the linking group comprises a (poly) alkylene glycol group having from 1 to 25 alkylene glycol units, preferably from 2 to 10 alkylene glycol units, more preferably from 3 to 6 alkylene glycol units.

In an embodiment, the alkylene group moieties comprise ethylene glycol units, preferably at least 3 ethylene glycol units.

In an embodiment, at least a part of the non-functionalized repeating units E1, E2 of the first functionalized polyelectrolyte polymer A and/or of the second functionalized polyelectrolyte polymer B comprises a linking group, wherein the linking group preferably comprises a (poly) alkylene glycol group having from 1 to 25 alkylene glycol units.

In particular, the linking groups may be molecules with antifouling properties. Examples of molecules with antifouling properties are (poly) alkylene glycol groups, such as polyethylene glycol (PEG) and oligomeric ethylene glycol units (OEG).

Particularly, for the functionalized surface according to the invention, the fraction of electrolyte repeating units of the functionalized polyelectrolyte polymer, preferably PLL, that is provided with bound linking groups, preferably having antifouling properties, at the surface of the solid substrate is between 1% and 70% of the electrolyte repeating units on the functionalized polyelectrolyte polymer molecules, preferably between 2.5% and 60%, more preferably between 5% and 50%, most preferably between 10% and 45%, such as 20%, 25%, 30%, 35%, 40%.

### (Functional Groups)

The functional groups may be any molecule which contains a first coupling moiety A1 or a second coupling moiety B1.

### (First Coupling Moiety A1 and Second Coupling Moiety B1)

It is part of the invention that the functionalized surface according to the invention comprises a functional moiety comprised by the functional groups, wherein said functional moiety comprised by the functional groups is any one or more of tetrazine, trans-cyclooctene, maleimide, dibenzocyclooctyne, diazirine, (4-iodoacetyl)aminobenzoate), disuccinimidyl tartrate, bis(2-(succinimidooxycarbonyloxy)ethyl)sulfone, azide, SPDP, [4-(psoralen-8-yloxy)]-butyrate, phosphine, 6-(4′-azido-2′-nitrophenylamino) hexanoate, and biotin.

In an particular embodiment, the first coupling moieties A1 is selected from any one or more of tetrazine, trans-cyclooctene, maleimide, dibenzocyclooctyne, diazirine, (4-iodoacetyl)aminobenzoate), disuccinimidyl tartrate, bis(2-succinimidooxycarbonyloxy)ethyl)sulfone, azide, SPDP, [4-(psoralen-8-yloxy)]-butyrate, phosphine, 6-(4′-azido-2′-itrophenylamino) hexanoate, and biotin.

In a preferred embodiment, the first coupling moieties A1 is selected from any one or more of tetrazine, trans-cyclooctene, maleimide and dibenzocyclooctyne.

In an embodiment, the functionalised repeating units G2 of the second functionalized polyelectrolyte polymer B are functionalized by the presence of any one or more second coupling moiety B1 independently selected from a thiol group and an amine, when the first coupling moieties A1 comprises maleimide, a strained alkyne and a strained alkene, such as trans-cyclooctene, when the first coupling moieties A1 comprises tetrazine, tetrazine, when the first coupling moieties A1 comprises trans-cyclooctene, and azide, when the first coupling moieties A1 comprises dibenzocyclooctyne.

Preferred functionalized surfaces of the first substrate of the invention comprise the first functional moiety, wherein said first functional moiety is selected from any one or more of tetrazine, trans-cyclooctene, maleimide and dibenzocyclooctyne. When the first functional moiety is selected from any one or more of tetrazine, trans-cyclooctene, maleimide and dibenzocyclooctyne, the functionalized surfaces of the second substrate is/are functionalized by the presence of any one or more of a second functional moiety selected from a thiol group and an amine for binding to maleimide, a strained alkyne and a strained alkene such as trans-cyclooctene for binding to tetrazine, tetrazine for binding to trans-cyclooctene, and azide for binding to dibenzocyclooctyne, according to the invention.

In an embodiment, the first coupling moieties A1 of the first functional group is a single first coupling moiety A1, preferably selected from tetrazine, trans-cyclooctene, maleimide and dibenzocyclooctyne. Thus, it is preferred that the functionalized surface according to the invention comprises a first functional moiety of a single kind, such as either tetrazine, or trans-cyclooctene, or maleimide, or dibenzocyclooctyne. This way, functionalized surfaces are applicable for the manufacturing of a further functionalized surface part (also defined as receptor area) based on for example receptor molecules of a single kind provided with the counterpart functional moiety of the first functional moiety in the click-chemistry binding reaction. Of course, combinations of different receptor molecules such as various sequences of oligonucleotides, can be provided with a single type of the second functional moiety for the click-chemistry step with the first functional moiety exposed on the functionalized surface of the invention.

In another embodiment, the first coupling moieties A1 of the first functional group is two or more first coupling moieties A1, preferably independently selected from tetrazine, trans-cyclooctene, maleimide and dibenzocyclooctyne.

### (Functionalized Surface)

In an embodiment, said functionalized surface of the first substrate and/or of the second substrate is a 1D surface, a 2D surface or a 3D surface provided as any one or more from a dot, a rod, a wire, a sheet, a film, a piece, a volume, a layer, a line, a ribbon and a plate.

Of course, it will be appreciated that the provision of a solid substrate comprising a different 1D, 2D or 3D configuration in the functionalized surface of the invention, is also part of the invention. For the purpose of applying a part of the functionalized surface of the invention in e.g. a biosensor of any kind, for example the presentation of the functionalized surface as a particle, a sheet or a 2D or 3D line or ribbon is beneficial. It is part of the invention that the functionalized surface is highly flexible with regard to the form and shape of the object made therefrom or the form and shape of the functionalized surface itself. There is a high extent of freedom for shaping the functionalized surface of the invention to the needs of the selected application in biosensing, and there is a high extent of freedom in selecting the form and shape of the solid support material that is provided with the polycationic polymer, the first molecule having antifouling property, etc. This way, the functionalized surface of the invention is suitable for application in e.g. batch wise biosensing configurations as well as in biosensing applications under (constant) flow, when for example the functionalized surface is presented as microparticles or as an immobilized support surface shaped as a sheet or the like, respectively.

For the method of bonding according to the invention it is beneficial that the functionalized surface at least in part is a 2D surface having a relatively flat area. More preferably, for bonding it is beneficial that the functionalized surface of a first substrate is substantially conformal to the functionalized surface of a second substrate, at least for the parts which are located inside the contact area during the contacting step and the covalent bonding step.

### (Polyelectrolyte Layer)

In an embodiment, the first functionalized polyelectrolyte polymer A is a first poly-cationic polymer A+ having cationic repeating units; and wherein step d. the forming of the functionalized surface on the first substrate is carried out by applying the first poly-cationic polymer A+ to an exposed surface of the first substrate.

In an embodiment, the second functionalized polyelectrolyte polymer B is a second poly-cationic polymer B+ having cationic repeating units; and wherein step e. the forming of the functionalized surface on the second substrate is carried out by applying the second poly-cationic polymer B+ to said exposed surface of the second substrate.

In particular, the functionalized surface according to the invention comprises a poly-cationic polymer molecule, wherein said poly-cationic polymer molecule which is adhered to the exposed surface of the respective substrate, is a mixture of different polymer molecules or is a polymer molecule of a single kind. For the purpose of controllability of the functionalized surface and/or for the purpose of the provision of a uniformly formed functionalized surface, application of a single type of polycationic polymer molecule is preferred, wherein the size distribution of the molecules is controlled and predetermined.

### (Polyelectrolyte Multilayer)

A multilayer of polyelectrolyte polymers may be formed by a layer by layer (LBL) deposition of polyelectrolyte polymers. Polyelectrolytes are known to be used in the formation of polyelectrolyte multilayers (PEMs). During LBL deposition, a suitable growth substrate (usually charged) may be dipped back and forth between dilute baths of positively and negatively charged polyelectrolyte solutions. During each dip a small amount of polyelectrolyte is adsorbed and the surface charge is reversed, allowing the gradual and controlled build-up of electrostatically “cross-linked” films of polycation-polyanion layers.

The LBL technique is based on the alternating assembly of oppositely charged polyelectrolytes, which is mainly driven by electrostatic interactions. The LBL technique has been applied for the engineering of planar substrates or colloidal particles. The PEM thickness and composition can be controlled with nanometer precision in the direction orthogonal to the surface of the substrate.

In an embodiment, the first functionalized polyelectrolyte polymer A is a first poly-anionic polymer A—having anionic repeating units; and wherein the method further comprises the step of:
h. forming a polyelectrolyte multilayer on an exposed surface of the first substrate, comprising adhering a poly-cationic polymer to said exposed surface of the first substrate and comprising carrying out step d. thereafter by applying the first poly-anionic polymer A—onto said exposed surface of the first substrate.

In an embodiment, the second functionalized polyelectrolyte polymer B is a second poly-anionic polymer B—having anionic repeating units; and wherein the method further comprises the step of:
i. forming a polyelectrolyte multilayer on an exposed surface of the second substrate, comprising adhering a poly-cationic polymer to said exposed surface of the second substrate and comprising carrying out step e. thereafter by applying the second poly-anionic polymer B—onto said exposed surface of the second substrate.

The bonding strength may be for example increased by means of layer-by-layer (LBL) assembly to make a polyelectrolyte multilayer of the invention. By alternating deposition of a functionalized poly-cationic polymer, such as PLL, of the invention and a poly-anionic polymer, such as polystyrene sulfonate (PSS), e.g. the probe density is increased into the 3rd dimension, to allow an increase in bonding strength.

The multilayer may contain other polyelectrolytes of the same or opposite charge, may contain other non-polyelectrolyte, charged or ionisable, additives, or charge-neutral additives, such as additives that enhance biocompatibility or that are bioactive. These other polyelectrolytes and additives may be included in a polyelectrolyte solution, or may be applied before or after a dip-coat in another manner.

In particular, in the LBL deposition, besides polyelectrolytes, other molecules, such as nanoparticles, lipid vesicles, and even cells can be assembled on top of multilayers or be placed at selected positions in the PEM, provided that they are charged or exhibit other types of supramolecular interactions with adjacent layers. PEMs fabricated from natural polyelectrolytes, such as poly-l-lysine (PLL), hyaluronic acid (HA), and alginate (Alg), among others, are very appealing for biological and medical applications due to their biocompatibility and biodegradability.

### (Contact Area)

In an embodiment, the functionalized surface of the first substrate and the functionalized surface of the second substrate comprise a respective contact part for forming the contact area in the contacting step f. As discussed above, for bonding according to the invention it is beneficial that the functionalized surface at least in part is a 2D surface having a relatively flat area. More preferably, for bonding it is beneficial that the functionalized surface of a first substrate is substantially conformal to the functionalized surface of a second substrate, at least for the parts which are located inside the contact area during the contacting step and the covalent bonding step.

### (Binding Concept-Covalent Bond)

### General

It is part of the invention that the bonding area (which corresponds to the contact area according to the invention) between the first substrate and the second substrate according to the invention comprises any one or more of pairs of first functional moiety and second functional moiety bound to each other selected from the list of pairs for respectively the first functional moiety and second functional moiety. Preferably the list of pairs for respectively the first functional moiety and second functional moiety consists of tetrazine and a strained alkyne and/or a strained alkene such as trans-cyclooctene, trans-cyclooctene and tetrazine, maleimide and a thiol group and dibenzocyclooctyne and azide, preferably the functionalized surface comprises a plural of pairs of said first functional moiety and second functional moiety bound to each other.

It is part of the invention that the method of the invention provides the functionalized surface according to the invention. It is part of the invention that the step of bonding the first substrate to the second substrate implies the application of coupling chemistry, also referred to as conjugation, such as click chemistry, such as a copper-free click chemistry reaction. Moreover, it is part of the invention that said click chemistry may imply a binding reaction, in examples, between a thiol group and maleimide, between a strained alkyne or a strained alkene, such as trans-cyclooctene, and tetrazine, between tetrazine and trans-cyclooctene, and between azide and dibenzocyclooctyne. One of the many benefits of the method of the invention is that the method allows for controlling the surface density of the covalent bonding groups e.g. capable of binding the first substrate to the second substrate in the contact area.

According to embodiments of the invention, the functionalized surface according to the invention comprises the functional moiety, wherein said functional moiety is selected from any one or more of tetrazine, trans-cyclooctene, maleimide and dibenzocyclooctyne. These functional moieties are of particular benefit for the functionalized surface of the invention, since such functional moieties are capable of reacting with and therewith binding to yet further molecules which are provided with yet a further functional moiety that is involved in said reaction and binding, i.e. for example a thiol group suitable for binding to maleimide, a strained alkyne and a strained alkene such as trans-cyclooctene suitable for binding to tetrazine, tetrazine suitable for binding to trans-cyclooctene, and azide suitable for binding to dibenzocyclooctyne, to name a few. An important aspect of the invention is that such binding of functional moieties to each other evolves under relatively mild and biocompatible reaction conditions with regard to e.g. temperature, pH, (near) physiological salt concentration, known in the art.

Herewith, the bonding of the substrates using the functionalized surfaces of the invention is provided upon bringing together and binding molecules provided with the functional moieties as here outlined, to each other under reaction conditions that aid in preservation of the functionalized surface, and that does not include any risk to the environment due to the absence of harmful reactants, reaction solution constituents, reaction conditions, etc

Preferably, the functionalized surface according to the invention is a surface wherein essentially all or at least the majority of (first) functional moieties comprised in the contact area are bound to a complementary (second) functional moiety through the click chemistry reaction between the first functional moiety and the second functional moiety.

In a preferred embodiment, the percentage or fraction of linking groups that is connected with a functional group comprising the first functional moiety is (nearly) the same as the fraction of linking groups that is bound to the other second substrate upon the click chemical reaction between the first functional moiety and the second functional moiety.

### (The Covalent Bond Forming Process)

In an embodiment, the covalent bond forming step comprises maintaining a contact between first functionalized polyelectrolyte polymer A and the second functionalized polyelectrolyte polymer B at a pressure higher than 1 MPa, preferably higher than 5 MPa, more preferably higher than 10 MPa, wherein in particular the pressure is lower than 100 MPa, preferably lower than 50 MPa.

In an embodiment, the covalent bond forming step comprises maintaining a contact between first functionalized polyelectrolyte polymer A and the second functionalized polyelectrolyte polymer B for at least 0.5 minutes, preferably for at least 5 minutes, more preferably for at least 10 minutes, in particular for at least 20 minutes, at said pressure.

In particular embodiments, the covalent bond forming step comprises maintaining a contact between first functionalized polyelectrolyte polymer A and the second functionalized polyelectrolyte polymer B for at most 60 minutes, preferably for at most 45 minutes, more preferably for at most 30 minutes, at said pressure.

In an embodiment, the temperature during the covalent bond forming step is lower than 80° C., preferably lower than 50° C., more preferably lower than 40° C.

In particular embodiments, the bond forming step g. is performed substantially without solvent and/or substantially without a catalyst being present in the contact area between the first substrate and the second substrate. The coupling moieties A1, B1 can form a covalent bond between them at very mild conditions, i.e. without solvent and without catalyst and at low temperatures.

### (Receptor Area)

In an embodiment, at least one of the first substrate and the second substrate additionally comprises a receptor area, which is arranged outside the contact area, for receiving functionalized receptor molecules.

In an embodiment, the functionalized receptor molecules comprise one or more receptor coupling moieties R1 independently selected from any one or more of tetrazine, trans-cyclooctene, maleimide and dibenzocyclooctyne.

In an embodiment, the receptor area is part of the functionalized surface of the first substrate and/or the receptor area is part of the functionalized surface of the second substrate.

In an embodiment, the receptor area is formed by attaching a third functionalized polyelectrolyte polymer C to an exposed surface of said first substrate or an exposed surface of said second substrate, respectively, wherein the third functionalized polyelectrolyte polymer C comprises a plurality of electrolyte repeating units, wherein at least one of the electrolyte repeating units is a functionalized repeating unit G3 comprising a third functional group comprising a third coupling moiety C1, wherein preferably the third coupling moiety C1 is selected from tetrazine, trans-cyclooctene, maleimide and dibenzocyclooctyne. The third coupling moiety C1 may be selected independently of a selection of first coupling moiety A1 and a selection of second coupling moiety B1.

In an embodiment, the receptor area is located to be exposed to at least one enclosed space of the device selected from a chamber and a channel, which is formed after bonding the first substrate to the second substrate (step g).

In an embodiment, the method comprises at least one further step of:
j. binding functionalized receptor molecules comprising one or more receptor coupling moieties R1 to at least a part of the first coupling moieties A1 attached to the functional area of the functionalized surface of the first substrate;
k. binding functionalized receptor molecules comprising one or more receptor coupling moieties R1 to at least a part of the second coupling moieties B1 attached to the functional area of the functionalized surface of the second substrate;
l. binding functionalized receptor molecules comprising one or more receptor coupling moieties R1 to at least a part of the third coupling moieties C1 attached to the first substrate; and
m. binding functionalized receptor molecules comprising one or more receptor coupling moieties R1 to at least a part of the third coupling moieties C1 attached to the second substrate. In a preferred embodiment, poly-L-lysine (PLL) is functionalized with oligomeric ethylene glycol units (OEG) and functional groups (X), to yield a versatile biosensor layer that can be used as the specific recognition layer in a biomedical sensing device. In such a material, the PLL backbone ensures strong adhesion to various (negatively charged) surfaces, OEG ensures anti-fouling properties, and the functional group X provides attachment points for (bio) molecular receptors.

### (Functionalized Receptor Molecule)

In an embodiment, the functionalized receptor molecule is selected from any one or more of an antibody or fragment or derivative thereof, such as a Fab, scFv, one or more Vh domains, a nucleotide, a nucleic acid, such as DNA, RNA or PNA, a peptide, a protein, a cell-surface receptor or extra-cellular fragment thereof, a carbohydrate, a lipid, a ligand for an antibody or for an antigen or a cell surface receptor, and complexes, multimers, modified forms thereof, of natural origin and/or of synthetic origin.

In an embodiment of the use of a device according to the invention, the functionalized receptor molecule is a DNA probe or a PNA probe and wherein the analyte is a nucleic acid, preferably DNA or RNA.

### (Functionalizing the Functionalized Polyelectrolyte Polymer)

Procedures and examples to functionalize the functionalized polyelectrolyte polymer are described in detail below in the Examples.

Additionally, procedures and examples to functionalize polyelectrolyte polymers are described in detail in the following references, wherein the procedures to functionalize the polyelectrolyte polymers and the resulting functionalize polyelectrolyte polymers obtained from these procedures are hereby incorporated by reference:
J. Movilli, S. S. Choudhury, M. Schönhoff, J. Huskens, Chemistry of Materials 2020, 32, 9155-9166: doi: “Enhancement of Probe Density in DNA Sensing by Tuning the Exponential Growth Regime of Polyelectrolyte Multilayers”:
J. Movilli, R. Kolkman, A. Rozzi, R. Corradini, L. I. Segerink, J. Huskens, Langmuir 2020, 36, 4272-4279; doi: “Increasing the sensitivity of electrochemical DNA detection by a micropillar-structured biosensing surface”;
J. Movilli, D. Di Iorio, A. Rozzi, J. Hiltunen, R. Corradini, J. Huskens, ACS Applied Polymer Materials 2019, 1, 3165-3173; doi: ““Plug-n-Play” Polymer Substrates: Surface Patterning with Reactive Group-Appended Poly-l-Lysine for Biomolecule Adhesion”:
J. Movilli, A. Rozzi, R. Ricciardi, R. Corradini, J. Huskens, Bioconjugate Chemistry 2018, 29, 4110-4118; doi: “Control of Probe Density at DNA Biosensor Surfaces Using Poly(l-lysine) with Appended Reactive Groups”:
D. Di Iorio, A. Marti, S. Koeman, J. Huskens, RSC Advances 2019, 9, 35608-35613; doi: “Clickable poly-L-lysine for the formation of biorecognition surfaces”.

### Definitions

Unless defined otherwise, all technical terms and scientific terms used herein have the same meaning as commonly understood by the relevant skilled person.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein. Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

Furthermore, the various embodiments, although referred to as “preferred” or “e.g.” or “for example” or “in particular” are to be constrained as exemplary manners in which the invention may be implemented rather than as limiting the scope of the invention.

The term “comprising”, used in the claims, should not be interpreted as being restricted to the elements or steps listed thereafter: it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a functionalized surface comprising A and B” should not be limited to a functionalized surface consisting only of components A and B, rather with respect to the present invention, the only enumerated components of the functionalized surface are A and B, and further the claim should be interpreted as including equivalents of those components.

In addition, reference to an element by the indefinite article “a” or “an” does not exclude the possibility that more than one of the elements are present, unless the context clearly requires that there is one and only one of the elements. The indefinite article “a” or “an” thus usually means “at least one”.

The term “functionalization” has its regular scientific meaning throughout the text, and here refers to the provision of a surface or a molecule with a first molecule and/or a reactive group, which is a binding partner for yet a further molecule or surface, such that a functionalized surface or functionalized molecule is provided. Examples are the provision of a surface provided with bound functional moieties such as tetrazine moieties, maleimide moieties, trans-cyclooctene (TCO) moieties, and dibenzocyclooctyne (DBCO) moieties. A further example is the provision of a surface or a molecule with a bound binding partner for yet a further molecule, such as the provision of a surface or molecule comprising a tetrazine moiety with a bound alkene-labeled (bio) molecule such as an antibody, or such as the provision of oligoethyleneglycol (OEG) immobilized on PLL which is adhered to a Si or Au surface, with maleimide or with trans-cyclooctene (TCO) provided on the oligoethyleneglycol (OEG) molecule, with thiol-functionalized (bio) molecule such as a Cys-comprising peptide, or with tetrazine-labeled nucleotide such as DNA, respectively. The term “percentage functionalization” has its regular scientific meaning throughout the text, and here refers to the percentage of binding sites of a molecule or of a repeating unit that are functionalized.

The term “number percentage functionalization” refers to the percentage of repeating units that are functionalized.

The term “number-% of repeating units (x)” provided as a percentage has its regular scientific meaning throughout the text, and here refers to the number percentage of repeating units of a functionalized polyelectrolyte polymer, such as polycationic PLL, which is occupied by a linking group bound thereto, such as an OEG or PEG (the number of repeating units for PLL correspond to the number of cationic groups as each lysine repeating unit has one cationic group). The term “number-% of repeating units (y)” provided as a percentage has its regular scientific meaning throughout the text, and here refers to the number percentage of repeating units of a functionalized polyelectrolyte polymer, such as polycationic PLL, which is functionalized by a coupling moiety, such as functionalized by a functionalized linking group bound, thereto, such as an OEG or PEG functionalized with for example TCO, tetrazine, maleimide, DBCO.

The abbreviation PLL-OEG(x)-X(y) may be used for a PLLs modified with x % of OEG and y % of functional group X grafted to the repeating units of PLL.

The total number of OEG side chains (whether X-terminated such as TCO-terminated, maleimide-terminated, DBCO-terminated and tetrazine-terminated, or methoxy-terminated (i.e. when relating to non-functionalized OEG)) is selected as a (predefined, aimed for) percentage of all lysine repeating units present in the PLL, and the number of X-terminated OEG side chains is then a fraction of the total number of OEG chains bound to the PLL. The ratio of e.g. OEG and OEG-X on e.g. PLL may be established by preparing a series of copolymers of PLL-OEG(x %)-X(y %) by a one-step solution phase reaction between OEG-X, OEG and PLL at the desired stoichiometric ratio.

The term “poly” as in “polymer” has its regular scientific meaning throughout the text, and here refers to a molecule whose structure is composed of multiple repeating units, from which originates a characteristic of high relative molecular mass and attendant properties. The units composing polymers derive, actually or conceptually, from molecules of low relative molecular mass.

The term “surface” as in for example “functionalized surface” has its regular scientific meaning throughout the text, and here refers to the exposed side of a 1D or 2D or 3D solid substrate or carrier material such as a dot, a rod, a wire, a sheet, a film, a piece, a volume, a particle, a microparticle, a nanoparticle, a line, a ribbon, or a plate, of for example a glass, silicon, silicon oxide, silicon/silicon oxide, titanium oxide, a metal oxide, a polymer material, or a metal, such as gold, the exposed side available for adsorption and/or binding of molecules capable of functionalizing said exposed side, and the exposed side configured for exposure to an analyte such as an analyte in a fluid sample, such as a biological liquid sample comprising the analyte.

The term “coupling moiety” has its regular scientific meaning throughout the text, and here refers to a part of a molecule that participates in similar chemical reactions in most molecules that contain such group.

The term “poly-L-lysine” and the term “PLL” have their regular scientific meaning throughout the text, and here refers to a lysine homopolymer, which has specific unique stereochemistry and specific unique link position. The precursor amino acid lysine contains two amino groups, one of which is at the α-carbon. With the amino group at the α-carbon location during polymerization, results in a-polylysine. The a-polylysine is a synthetic polymer, which can be composed of either

L-lysine or D-lysine, or of a mixture of both stereoisomers. “L” and “D” refer to the chirality at lysine's central carbon. This results in poly-L-lysine (PLL), poly-D-lysine (PDL), and poly-DL-lysine respectively. Polylysine, regardless of chirality, is a homopolypeptide belonging to the group of cationic polymers: at pH 7, polylysine contains a positively charged hydrophilic amino group.

The term “strained” such as in “strained alkyne” and “strained alkene” has its regular scientific meaning throughout the text, and here refers to strained unsaturated molecules having the (unique) ability to undergo (3+2) and (4+2) cycloadditions with a diverse set of complementary reaction partners. Accordingly, chemistry centered around strain-promoted cycloadditions is applicable to precisely modify (bio) polymers, ranging from nucleic acids to proteins to glycans. For example, presence of a strained alkyne or strained alkene as a functional moiety in a (bio) molecule allows for efficient and rapid attachment to another molecule provided with tetrazine as the functional moiety counterpart for binding interaction with the strained alkyne or strained alkene.

The term “click-chemistry”, as for example in “copper-free click chemistry” applied in chemical synthesis, has its regular scientific meaning in the application, and here refers to a class of biocompatible small molecule reactions commonly used in bioconjugation, where it is used for allowing the joining of substrates of choice with specific biomolecules. Click chemistry refers to a way of generating products that follow examples in nature, which also generates substances by joining small modular units. In general, click reactions usually join a biomolecule and a reporter molecule. Click chemistry is not limited to biological conditions: the concept of a “click” reaction has been used in pharmacological and various biomimetic applications. However, they have been made notably useful in the detection, localization and qualification of biomolecules. Click chemistry, i.e. click reactions occur in one pot, are not disturbed by water, generate minimal and inoffensive byproducts, and are ‘spring-loaded’, that is to say, click chemistry is characterized by a high thermodynamic driving force that drives it quickly and irreversibly to high yield of a single reaction product, with high reaction specificity (in some cases, with both region- and stereo-specificity). These qualities make click reactions particularly suitable to the problem of isolating and targeting molecules in complex biological environments. In such environments, products accordingly need to be physiologically stable and any byproducts are most preferably to be non-toxic. Click chemistry is thus a method for attaching a probe or substrate of interest to a specific biomolecule, a process called bioconjugation. In order for this technique to be useful in biological systems and biochemical systems, click chemistry must aim at or near biological conditions, produce little and (ideally) non-toxic byproducts, have (preferably) single and stable products at the same conditions, and proceed quickly to high yield in one pot. Existing reactions, such as Staudinger ligation and the Huisgen 1,3-dipolar cycloaddition, have been modified and optimized for such reaction conditions. A desirable click chemistry reaction therefore: is modular: is wide in scope: gives very high chemical yields: generates only inoffensive byproducts: is stereospecific: is physiologically stable: exhibits a large thermodynamic driving force (>20 KJ/mol) to favor a reaction with a single reaction product. A distinct exothermic reaction makes a reactant ‘spring-loaded’. The click chemistry reaction process would thus preferably: have simple reaction conditions: use readily available starting materials and reagents: use no solvent or use a solvent that is benign or may easily be removed (preferably water): provide simple product isolation by non-chromatographic methods (crystallisation or distillation): have high atom economy. In the context of the invention, the term ‘click chemistry’ is used to refer to ‘copper-free click chemistry’ reactions, unless specified differently. In the context of the current invention, typical click chemistry applicable for the provision of the functionalized surface of the invention is the reaction between for example a thiol group and maleimide, a strained alkyne, or a strained alkene such as trans-cyclooctene, and tetrazine, tetrazine and trans-cyclooctene, and azide and dibenzocyclooctyne, to name a few.

The terms “binding” and “bonding” in the context of covalent bonds of a molecule both refer to a reaction to form said covalent bond of the molecule.

The term “biotin” both refer to a free biotin molecule, a bound biotin molecule or a coupled biotin.

### BRIEF DESCRIPTION OF THE FIGURES

The accompanying drawings are used to illustrate presently preferred non-limiting exemplary embodiments of devices of the present invention. The above and other advantages of the features and objects of the invention will become more apparent and the invention will be better understood from the following detailed description when read in conjunction with the accompanying drawings, in which:

FIG. 1 is a schematic representation of the COC surface functionalization with modified PLL followed by the ‘low temperature’ binding of the substrates. After oxygen plasma treatment, COC substrates were functionalized either with PLL-OEG-DBCO (blue, 100) or PLL-OEG-N₃ (yellow, 200). Afterwards, substrates were placed on top of each other and a pressure was applied for a certain time in order to achieve a strong bonding:

FIGS. 2A and 2B show Fluorescence microscopy images of azide-fluor 488 on COC after patterning of (a) PLL-OEG-DBCO or (b) PLL-OEG-N₃ (control) by micromolding in capillaries (MIMIC):

FIG. 3A and FIG. 3B show a chemical formula of PLL-OEG-DBCO and PLL-OEG-N₃, respectively:

FIG. 4 shows a schematic reaction for the synthesis of PLL-OEG-DBCO:

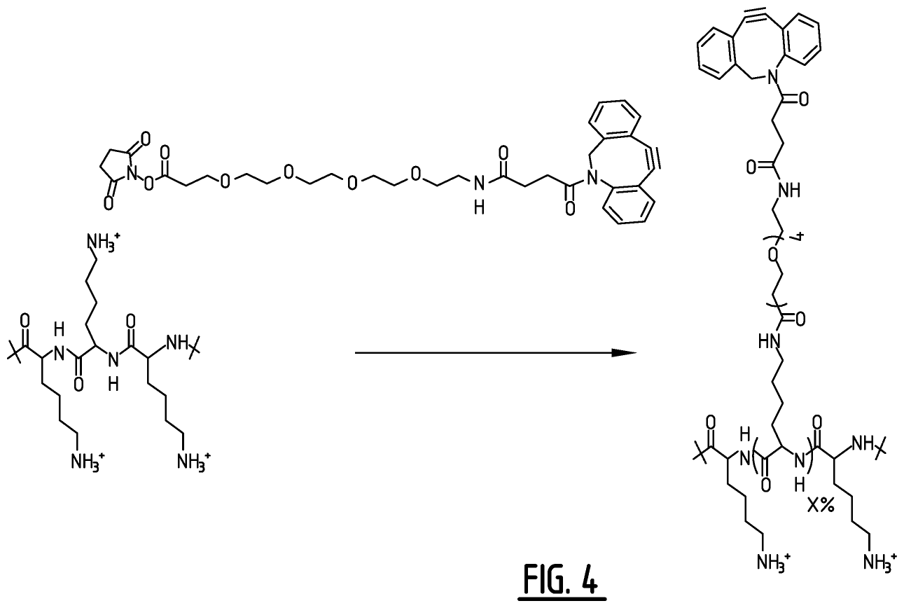

FIG. 5 shows a NMR spectrum of PLL-OEG-DBCO:

FIG. 6 shows a schematic reaction for the synthesis of PLL-OEG-N₃;

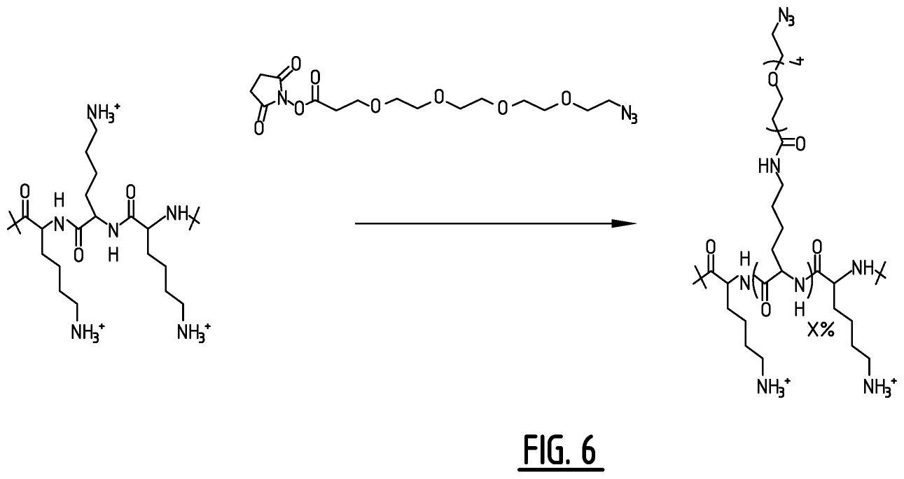

FIG. 7 shows a NMR spectrum of PLL-OEG-N₃.

### EXPERIMENTAL SECTION

### Materials

Poly-l-lysine hydrobromide (MW=15-30 kDa), azide-fluor-488 (≥90%, HPLC) and PBS (phosphate buffered saline) tablets were purchased from Sigma-Aldrich. NHS-OEG₄-methyl and Spectrum 6-8 kD MWCO standard RC dry dialysis membrane tubing (0.32 mL/cm vol./length) were purchased from Thermo Fisher Scientific. NHS-OEG-DBCO and NHS-OEG₄-N₃ were purchased from Click Chemistry Tools. Sylgard 184 base silicone elastomer and Sylgard 184 curing agent silicone elastomer to fabricate PDMS chips were obtained from Farnell. COC6013, 1.1 mm was purchased from Axxicon, e-COC COC-E140, 100 μm (on 125 μm PET) was purchased from Tekniplex.

### Stock Solution

### Phosphate Buffered Saline

Stock solutions of 0.01 M PBS were prepared having a pH of 7.4. This was done by dissolving a salt package from Sigma Aldrich in 1 L of MilliQ water. This solution was kept at room temperature and filtered before every experiment.

### Poly-L-Lysine

A stock solution of 10 mg/mL Poly-L-Lysine in PBS (pH 7.0) was prepared. This was done by dissolving 100 mg Poly-L-Lysine hydrobromide in 10 mL PBS. This stock solution was kept at −20° C.

### Substrates

Typical T_{g} (glass transition temperature) of solid polymeric substrates are mentioned in the following Table:

TABLE 1
T_{g} of substrates

| Material name | Acronym | Grade or brand | Tg/° C. |
|---|---|---|---|
| Cyclic olefin copolymer | COC | 6013 | 136 |
| Cyclic olefin copolymer | COC | 8007 | 78 |
| Cyclic olefin copolymer | COC | 6015 | 156 |
| Cyclic olefin copolymer | COC | 5013 | 135 |
| Cyclic olefin copolymer | COC | 6017 | 176 |
| Polycarbonate | PC | Makrolon | 150 |
| Poly(methyl | PMMA | Perspex | 105 |
| methacrylate) | | | |
| Polystyrene | PS | Amorphous | 90 |
| Poly(ether ether ketone) | PEEK | | 143 |
| Poly(tetrafluoroethylene) | PTFE | | — |
| Polyoxymethylene | POM | Copolymer | −30 |
| Poly(vinyl chloride) | PVC | | 82 |
| Poly(dimethyl siloxane) | PDMS | Sylgard 184 | −125 |
| Off-stoichiometry | OSTE(X) | variable | variable |
| thiol-ene(-epoxy) | | | |
| Polyterephthalate | PET | PET-G | 67-81 |
| Styrene-ethylene- | SEBS | | −55 (hard phase), |
| butylene-styrene | | | 95 (soft phase) |

### Measurements/Methods

### Fluorescence Microscopy

Fluorescence microscopy images were taken in air using an Olympus inverted research microscope IX71 (U-RFL-T light source, digital Olympus DP70 camera). A red filter was used (λₑₓ=500 nm, λₑₘ=535 nm).

### NMR

All the polymers were characterized with ¹H-NMR and 13C-NMR: spectra were recorded on a Bruker 400 MHz spectrometer. Chemical shifts were reported in ppm with tetramethylsilane as an internal standard.

### Surface Activation

Before a surface can be functionalized by adherence of an electrolyte polymer, such as modified PLL, such as PLL-OEG and PLL-OEG-X, with X being a coupling moiety according to the invention, the surface, such as a cyclic olefin polymer surface, silicon surface or gold surface, must first be activated. There are for example three techniques to achieve activation, known to the skilled person.

A first technique known in the art is treatment of a surface with oxygen plasma. Oxygen plasma refers to the treatment of a nonmetallic surface with a plasma consisting of oxygen. This plasma is generated under vacuum. The oxygen is used to clean the surface by cleaving organic bonds. Besides cleaning it also increases the wettability of the surface. This is done by creating a layer of oxide on top of the surface, resulting in a higher hydrophilicity.

A second technique is UV-ozone treatment of a surface. This ETV-ozone treatment method shows similarities with the oxygen plasma treatment method in working principles. However, UV-ozone treatment is performed under atmospheric pressure and the method uses ozone instead of oxygen. UV light is provided by a device provided with a UV lamp. The UV radiation cleaves O₂ in atomic oxygen and ozone. This ozone gets cleaved again into atomic oxygen. The atomic oxygen then reacts with the surface of interest by cleaving organic bonds and oxidizing it.

A third technique known in the art is characterized by the application of a so-called piranha solution. This solution consists of a mixture of concentrated (95% volume/volume) sulfuric acid in water and 30% (volume/volume) hydrogen peroxide based on the volume in water, in a 3:1 ratio. The piranha solution is a very potent acid and oxidizing agent which proceeds to degenerate organic compounds on the surface and leaving the surface activated.

### Micromolding in Capillaries (MIMIC)

PDMS stamps were fabricated according to known procedures by curing Sylgard 184 (10:1 v/v mixture) on the surface of the master at 60° C. overnight. After cutting the PDMS in small MIMIC molds, the PDMS stamps were cleaned by sonication ethanol and dried with nitrogen. Subsequently, the stamps were activated by oxygen plasma (Plasma Prep II) for 1 min at 200-230 m Torr and 40 mA. After placing the stamp on top of the activated COC an amount of 10-20 μL of the desired 0.1 mg/mL modified PLL solution (PBS, pH 7.4) was placed at the open edge of the PDMS stamp and the channels were filled with the modified PLL solution as a result of the capillary forces.

### Examples

An example of the invention is to develop a suitable treatment that will not only lead to a strong bonding strength for bonding below T_{g} but can also allow durable hydrophilicity and biocompatibility to substrates, such as substrates containing cyclic olefin copolymer (COC). In this example we show a surface functionalization method for a room temperature and solvent free bonding of COC substrates, exploitable for the fabrication and functionalization of microfluidic devices. For this purpose, PLL functionalized polymers were used, which were modified with click chemistry moieties. The fast and stable adsorption of PLL onto plastic material in combination with the high yields and reaction rates of catalyst free click chemistry reactions allows a quick and stable bonding of plastic substrates. The aim is to introduce functional surface groups at the interface onto substrates, such as plastic substrates, to provide wash-stable and storage-stable hydrophilic surfaces, and which will allow the bonding at room temperature of two substrates with the possibility of further functionalizing the substrates.

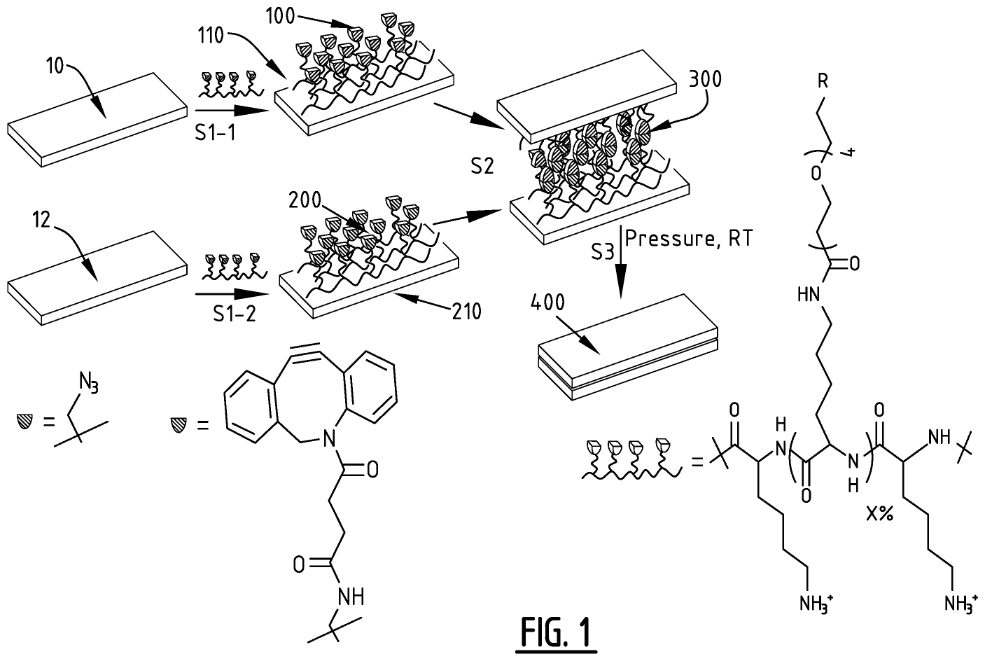

In FIG. 1 an example of a stepwise approach is shown for the modification and the bonding of surfaces of substrates, such as COC substrates. Hereto, after activation of the surfaces of the substrates 10, 12, in step S1-1 PLL functionalized with dibenzocyclooctyne (DBCO) coupling groups 100 was adsorbed onto a substrate 10 and in step S1-2 PLL functionalized with azide (N₃) coupling groups 200 was adsorbed onto a substrates 12, respectively, such as COC substrates. In step S2 the functionalized substrate surfaces 110, 210 displaying the reactive coupling groups 100, 200 at the interface were then placed on top of each other in a contact area 300 and in Step S3 a pressure was applied at room temperature and without the use of any solvent in order to obtain a stable substrate assembly 400 bonding between the substrates 10 and 12 by covalent bond formation by the coupling groups 100 and 200.

### Synthesis of Modified PLL

All modified (i.e. functionalized) PLLs were synthesized according to known procedures:

### Example 1 (Maleimide)

PLL-OEG-X polymers were synthesised, wherein X was chosen to be maleimide. PLL-OEG₄-Mal was synthesised. An H-NMR spectrum was measured for PLL-OEG₄(30)-Mal(8) (30% OEG, 8% maleimide) after it was purified.

The synthesis reaction is presented in Scheme 1. PLL·HBr (1) is reacted with given relative ratios of Mal-OEG₄-NHS (3, y=0.5-22%) and methyl-OEG₄-NHS ester (2, x=18-35%) in phosphate buffered saline (PBS) at pH 7.2, for 4 hours at room temperature, to give compound (4) with the desired degrees of functionalisation. Scheme 1 shows the synthetic approach for variation of the fractions of OEG (x) and functional coupling group X (here: maleimide) (y) in functionalized PLL-OEG-X. NMR results have been obtained that confirm successful functionalization with a variety of functional groups (biotin, maleimide, tetrazine, azide, TCO, DBCO) and with varying compositions.

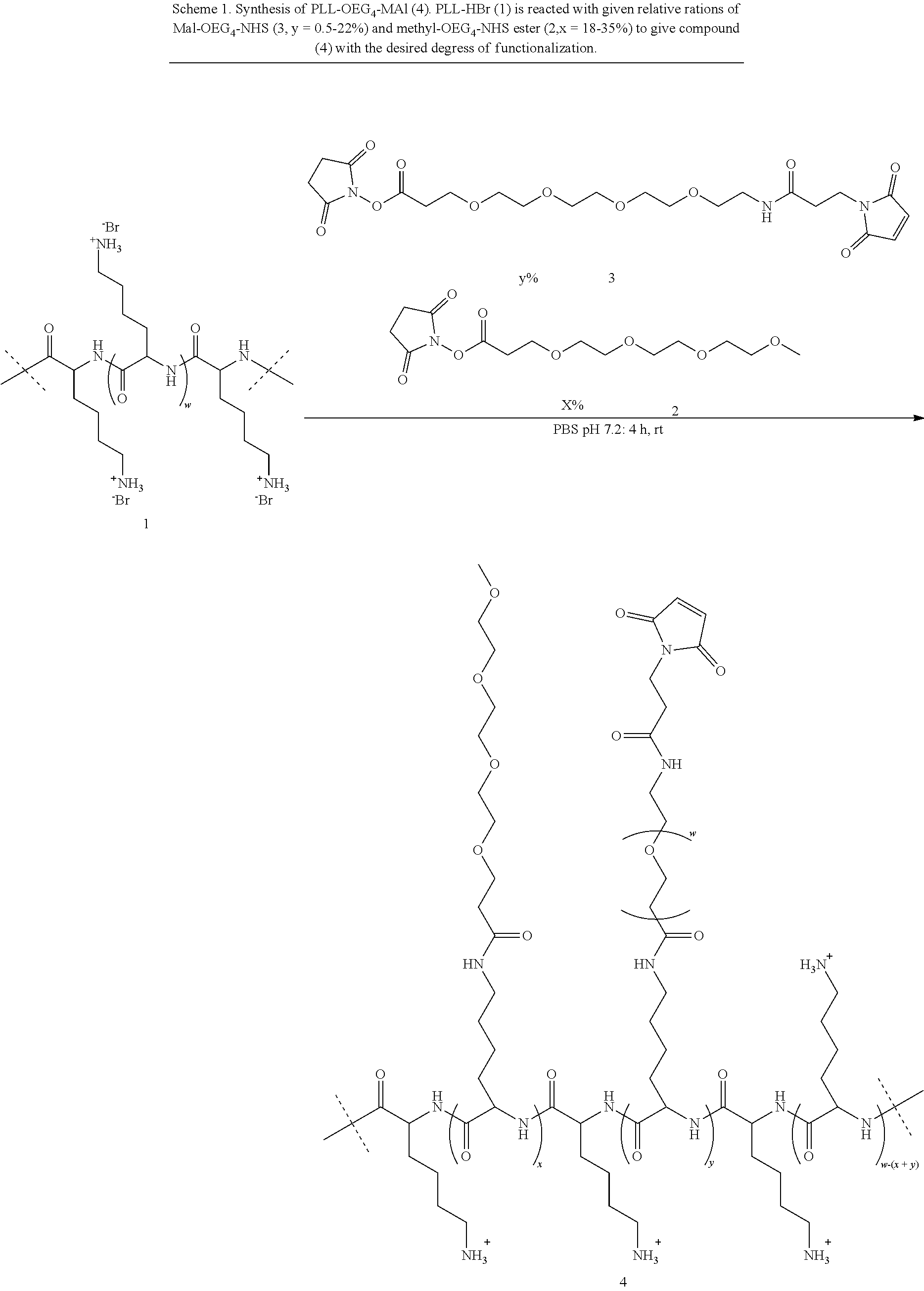

The abbreviation PLL-OEG(x)-X(y) may be used for a PLLs modified with x % of OEG and y % of functional group X grafted to the PLL. 1H-NMR was used to quantify the specific degree of functionalization of the polymer for OEG (X) and X(y) separately and to determine the total degree of functionalization (x+y) of the polymer.

### Example 2 (DBCO)

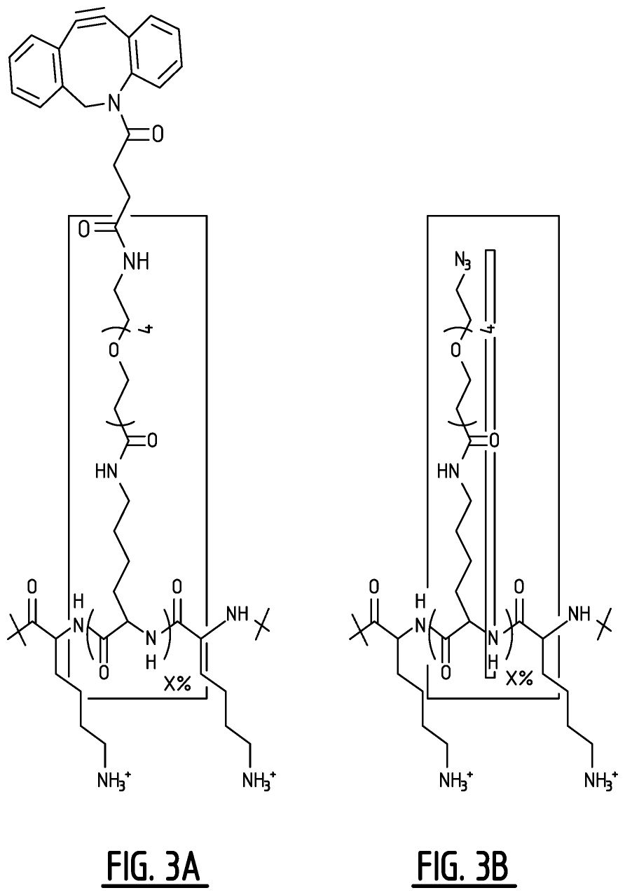

FIG. 3A shows a chemical formula of functionalized PLL-OEG-DBCO.

PLL (M_{w} 15-30 kDa) was functionalized in a one-step reaction, by adding NHS-(OEG)₄-DBCO to the PLL polymer in PBS buffer with desired ratios. The catalyst-free click-chemistry moieties were chosen here as reactive groups due to their high yield and the reported mild reaction conditions. In particular, DBCO represents one of the most efficient reagents employed in the strain-promoted alkyne-azide cycloadditions (SPAAC), in which strained alkynes in cyclooctyne selectively react with azides under physiological conditions and without the use of any cytotoxic catalyst such as copper. The presence of these reactive groups enables the formation of a biocompatible coating at mild reaction conditions. The short OEG spacer between the PLL backbone and the reactive moiety is employed to ensure good antifouling properties of the PLL coating. At the same time, the OEG chain enables a good displacement of the reactive moieties at the outer side of the surface, thus allowing a more efficient reaction.

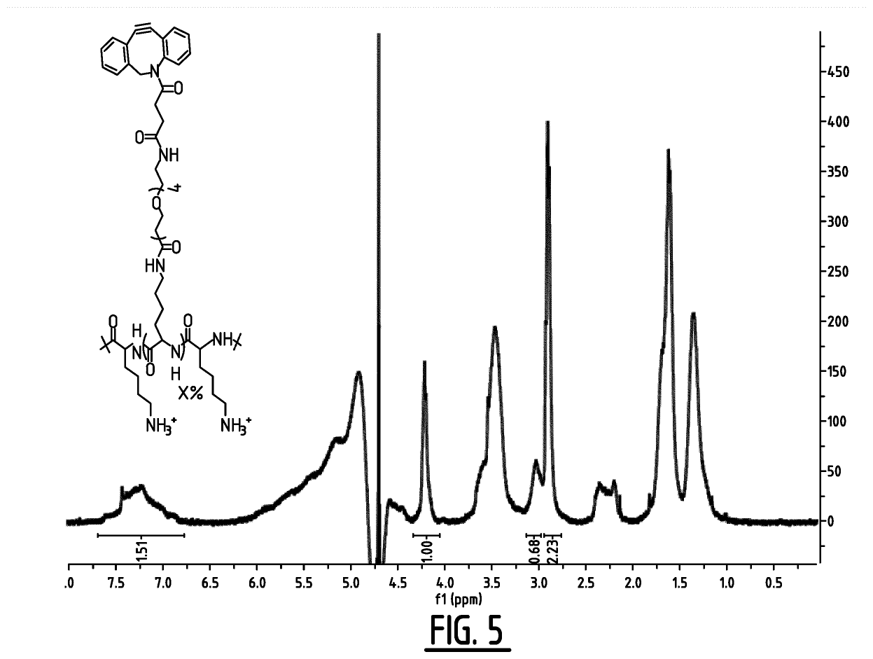

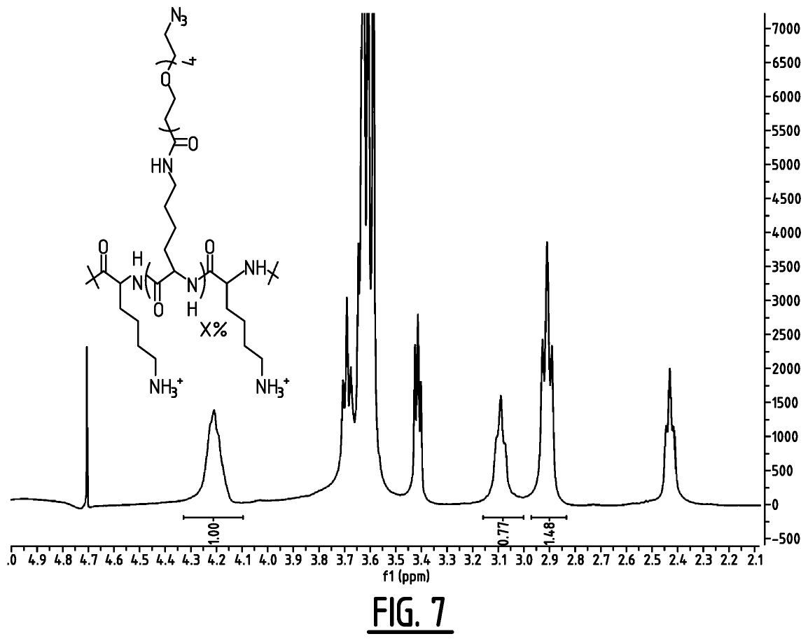

By tuning the molar ratios the reaction mixture, various degrees of functionalization of PLL can be achieved. 1H-NMR was used to characterize the formation of the copolymers and to calculate the exact degree of PLL functionalization (see e.g. FIG. 5 and FIG. 7). In particular, the observed presence of the characteristic peaks of the DBCO in the aromatic area of the NMR spectra, confirmed the presence of this moiety also in the modified PLL. Moreover, by following the splitting of the peak at 2.95 ppm, typical of the protons of the CH₂ group next to the non-functionalized amino group of the PLL, the functionalization of the polymer was confirmed.

A PLL functionalization selected in the range of 5% to approximately 40% of the lysine repeating units was aimed for DBCO. A 23% (y) functionalization was obtained with PLL-OEG-DBCO. A relatively low yield obtained for PLL-OEG-DBCO may be due to a larger steric hindrance of the DBCO moieties in comparison to PLL-OEG-N₃ (see Example 3). However, higher functionalization degrees up to 40% are obtainable as described in WO2018222034A1 on pages 68-69.

### Example 3 (N₃)

FIG. 3B shows a chemical formula of functionalized PLL-OEG-N₃.

PLL·HBr in filtered PBS buffer (pH 7.4) was provided at a concentration of 10 mg/mL. A desired stoichiometric ratio (in comparison with the lysine monomer) of NHS-OEG₄-methyl and NHS-OEG₄-N₃ were added simultaneously to the mixture. The mixture was reacted for 4 h at room temperature. Subsequently the solution was dialyzed using cellulose membrane with a cut-off of 6-8 KDa for 3 days and thereafter freeze-dried overnight. Quantification of the functionalization percentages of compounds were performed using the integral ratios of the characteristic signals in the 1H NMR spectra (400 MHz D₂O, pH 6.5) according to known procedures. All the integrals were normalized using the peak at 4.29 ppm related to the lysine backbone.

A PLL functionalization selected in the range of 5% to approximately 40% of the lysine repeating units was aimed for N3. A 35% (y) functionalization of PLL repeating units was obtained for PLL-OEG-N3.

### Example 4 (DBCO)

This is another example for functionalizing PLL with dibenzocyclooctyne (DBCO).

PLL HBr in filtered PBS buffer (pH 7.4) was provided at a concentration of 10 mg/mL. A desired stoichiometric ratio (in comparison with the lysine monomer) of NHS-OEG₄-methyl and NHS-OEG₄-DBCO were added simultaneously to the mixture. The mixture was reacted for 4 h at room temperature. Subsequently the solution was dialyzed using cellulose membrane with a cut-off of 6-8 KDa for 3 days and thereafter freeze-dried overnight. Quantification of the functionalization percentages of compounds were performed using the integral ratios of the characteristic signals in the 1H NMR spectra (400 MHZ D₂O, pH 6.5) according to known procedures (see e.g. WO2018222034A1 on page 50-52 for determining functionalization degree by tetrazine functional group instead of a DBCO functional group). All the integrals were normalized using the peak at 4.29 ppm related to the lysine backbone.

### Other Examples

Maleimide modified PLL

Examples for obtaining maleimide modified PLL (PLL-OEG-mal) are described in detail in WO2018222034A1 on pages 40-41, and on page 45, which are incorporated by reference.

### Tetrazine Modified PLL

Examples for obtaining tetrazine modified PLL (PLL-OEG-tetrazine) are described in detail in WO2018222034A1 on page 47, which are incorporated by reference. Quantification of the functionalization percentages of compounds were performed using the integral ratios of the characteristic signals in the 1H NMR spectra according to known procedures. (see e.g. WO2018222034A1 on page 50-52 for determining functionalization degree by tetrazine functional group).

Alternative modified PLLs having a coupling functional moiety and/or having another degree of functionalization per lysine repeating unit may also be synthesized according to procedures as described in D. Di Iorio. A. Marti. S. Koeman and J. Huskens. RSC Adv., DOI: 10.1039 c9ra08714a.

### Adsorption Quality on Substrate Surface

In a following step, the adsorption of modified PLL materials of Example 3 and Example 4 onto COC surfaces, as well as the stability of the coating, was investigated. Preliminary experiments were conducted with elastomeric COC (eCOC) surfaces. eCOC surfaces were activated with oxygen plasma for 1 minute and subsequently immersed in a PBS solution containing either PLL-OEG-DBCO or PLL-OEG-N₃ (0.1 mg/mL) for 15 min.

The exposure of surfaces to oxygen plasma results in the formation of oxygen containing groups and in a largely negatively charged surface. The charges of the surfaces enable the adsorption of the positively charged PLL from aqueous solution through a stable polyvalent electrostatic interaction. Static contact angle goniometry was used to confirm the activation of surfaces and to first assess the PLL self-assembly on the substrates, see Table 2.

TABLE 2
Contact angle values of eCOC substrates before and after activation,
and after immersion in PLL—OEG—DBCO or PLL—OEG—N₃
solution in PBS 7.4 (control substrates dipped only PBS solution).
Thereafter, substrates where rinsed with Milli-Q water.

| | Before | After | | |
|---|---|---|---|---|
| Materials | Activation | Activation | Day 0 | Day 1 |
| Bare eCOC (control) | 90° | <10° | <10° | 38° |
| Bare eCOC + PBS (control) | 90° | <10° | 30° | 36° |
| eCOC + PLL—OEG—DBCO | 90° | <10° | 44° | 39° |
| eCOC + PLL—OEG—N₃ | 90° | <10° | 44° | 46° |

As shown in Table 2, a drastic reduction of contact angle values was observed after oxygen plasma activation, confirming the change of hydrophobicity of the surface. Importantly, the transparency of the surface was kept after activation. After addition of functionalized PLL, the values of contact angle for PLL functionalized substrates were observed to be approximately 44°, clearly higher than values obtained in the control experiment, where no PLL was added. These results confirmed the formation of a functionalized PLL layer on the eCOC surface.

The stability of the coating over time and/or in particular conditions (e.g. in high/low pH solutions) represent an important point in the development of new surface modification methods. Therefore, the stability of the PLL coating on eCOC surfaces was subsequently investigated.

The stability of PLL was monitored by means of fluorescence microscopy, using a dye-labeled PLL for monitoring the presence of bound PLL over time.

In particular, PLL-OEG-DBCO was patterned onto eCOC surfaces by using a PDMS stamp (containing channels 100 μm wide and spaced 100 μm) by micromolding in capillaries (MIMIC), following a procedure described above (see also procedures described in J. Movilli, D. Di Iorio, A. Rozzi, J. Hiltunen, R. Corradini and J. Huskens, ACS Appl. Polym. Mater., 1, 3165-3173; which are incorporated by reference).

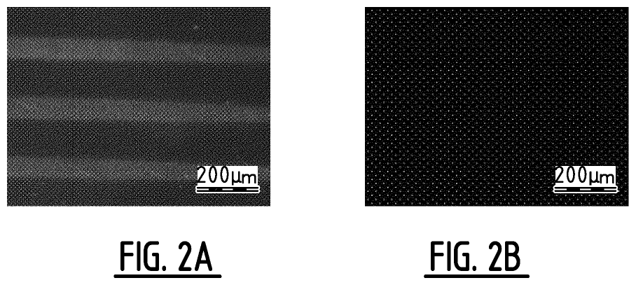

After removal of the PDMS stamp and copious rinsing of the COC substrate with MilliQ, azide-fluor 488 (1 μM in PBS, pH 7.4) was added on the surface for 30 min. FIG. 2A shows the clear fluorescent pattern obtained after the functionalization of the substrates, owing first to the successful functionalization of PLL-OEG-DBCO onto the surfaces and the subsequent reaction with azide-fluor 488. The black empty areas in between the lines indicate that the azide-fluor 488 binds specifically to the PLL-DBCO deposited on the surface. A control experiment, in which same patterns were made with PLL-OEG-N₃, and in which no click reaction can occur, showed the absence of the fluorescence patterns (FIG. 2B) and confirmed the good antifouling behavior of the locally adsorbed PLL on the COC substrate.

This method therefore further demonstrated the formation of a PLL coating onto the surfaces and resulted to be suitable for the study of the stability of the surfaces. The fluorescence of the patterned surfaces was therefore measured after 1 week storage in air at RT, and after immersion in buffer PBS, pH 7.4, in water, in DMF and in a high and low pH solutions. The visualization of the pattern after testing the functionalized surfaces in the above mentioned fluorescence conditions showed a clear stability and resistance of the formed polymeric coating for at least 1 week at RT. These results confirm the possibility of employing the proposed functionalization method for the fabrication of microfluidic devices.

### Bonding Formation

Thereafter, the formation of a stable bond of two COC substrates was investigated. For this purpose, a COC substrate (COC6013) was modified with PLL-OEG-DBCO and PLL-OEG-N₃ using the method as represented in FIG. 1. The presence of an open channel on one of the two surfaces allows to verification of a correct and strong sealing after bonding, by controlling leakage of solutions after the bonding of two surfaces. After the modification of the substrate with functionalized PLL, the functionalized sides of the substrate were put in contact. Thereafter, the substrates were placed under a press, wherein a pressure of 14.5 MPa (by 1000 Kg applied on 1.5 cm times 4.5 cm contact area) was applied for either 5 min or 30 min at room temperature without the addition of any solvent. After removal of the substrates from the press, the two substrates were bonded. The detachment of the two surfaces was not achieved by sliding the substrate or by applying an external force. Remarkably, the transparence of the COC substrates was kept also after the application of such a high pressure.

The same good result for bonding were obtained for other substrates using the same adsorbed functionalized polymers (PLL-OEG-DBCO and PLL-OEG-N₃, respectively) and using the same bonding conditions (14.5 MPa pressure at RT for at least 5 minutes without the addition of any solvent or catalyst.

In order to ensure that the bonding was ascribable exclusively to the PLL coating, several control experiments were performed. When the same pressure was applied on two bare surfaces (i.e. cleaned but not activated), or on two activated substrates or also on COC surfaces immersed in PBS (no PLL) buffer after activation, no bonding was obtained. No bonding was observed also when one of the two reactive groups was suppressed, i.e. when one substrate was immersed in PLL-OEG-N₃ and the other in non-functionalized PLL. The key role of the click chemistry moieties in the bonding process was therefore proven. Moreover, as positively charged PLL adsorbs on negatively charged surfaces, it is reasonable to attribute the bonding partially to pre electrostatic interactions between PLL and activated substrates. In order to exclude this, another control experiment was performed by applying a pressure on a COC substrate functionalized with unmodified PLL and a plasma activated COC substrate. Again, no bonding was obtained after 30 min.

Finally, in order to evaluate whether the strength of the obtained bonding is adequate for the realization of a microfluidic device, the bonded surfaces were tested by injecting a solution in the channel, gradually increasing the pressure by keeping the outlet closed. Pressures were increased until a leakage of the solution was observed. Bonded substrates/surfaces on which pressure was applied for 5 minutes and 30 minutes where both tested. Remarkably, surfaces bonded for 5 minutes held pressures up to 1750 mbar, while substrates bonded for 30 minutes showed good resistance up to 4300 mbar. For the latter, it was not possible to increase the pressure due to technical limitations. However, 2000 mbar are commonly used in microfluidic applications.

### Alternative Surface Functionalization and Bonding Conditions

In another example of surface functionalization and bonding conditions, the COC substrates (COC, e-COC) are cleaned by sonication in ethanol for 5 minutes and subsequently rinsed with water and dried by a stream of nitrogen. 0.2 mg/mL of functionalized PLL solution was incubated for 10 minutes on the substrate. For the bonding experiments 0.5 mg/mL PLL-OEG-DBCO and PLL-OEG-N₃ were immobilized for 20 min.

In summary, the use of modified poly-l-lysine polymers was demonstrated for the bonding of COC substrates at room temperature. Two COC surfaces functionalized with PLL-OEG-DBCO and PLL-OEG-N₃ showed resistant bonding when pressure was applied and were able to hold a pressure of 4300 mbar when fluid was pumped through the microchannel. PLL-based coatings showed stability over time and in several reaction conditions, proving their applicability in biosensing devices. The strategy outlined here to adhere multitasking modified PLL with customized appending groups on the surface resulted to be a promising method not only for the low temperature bonding of COC substrates but also for the specific and stable anchoring of biomolecules onto COC substrates in a subsequent step, maintaining ideal hydrophilic properties. The surface modification technique reported here offers a viable and potentially high-volume low cost production method for the fabrication of chips for bioanalytical and medical applications. The method can potentially be applied to a large range other thermoplastic materials presenting COC-like properties.

Whilst the principles of the invention have been set out above in connection with specific embodiments, it is to be understood that this description is merely made by way of example and not as a limitation of the scope of protection which is determined by the appended claims.

1-45. (canceled)

46. A method for forming a bond between two substrates of a device, comprising the steps of:
a. providing a first substrate and a second substrate of a device;
b. providing a first functionalized polyelectrolyte polymer A comprising a plurality of electrolyte repeating units, wherein at least one of the electrolyte repeating units is a functionalized repeating unit G1 comprising a first functional group comprising a first coupling moiety A1;
c. providing a second functionalized polyelectrolyte polymer B comprising a plurality of electrolyte repeating units, wherein at least one of the electrolyte repeating units is a functionalized repeating unit G2 comprising a second functional group comprising a second coupling moiety B1;
wherein the second coupling moiety B1 is selected to be complementary for forming a covalent bond to the first coupling moiety A1 at a temperature below 100° C.;
d. forming a functionalized surface on an exposed surface of the first substrate having the first functionalized polyelectrolyte polymer A attached to said first substrate;
e. forming a functionalized surface on an exposed surface of the second substrate having the second functionalized polyelectrolyte polymer B attached to said second substrate;
f. contacting at least a part of the functionalized surface of the first substrate onto at least a part of the functionalized surface of the second substrate thereby forming a contact area between the first functionalized polyelectrolyte polymer A and the second functionalized polyelectrolyte polymer B; and
g. forming a covalent bond between the first coupling moiety A1 and the second coupling moiety B1 in the contact area between the first substrate and the second substrate for binding the first substrate to the second substrate.

47. The method of claim 46, wherein the covalent bond forming step comprises maintaining a contact between first functionalized polyelectrolyte polymer A and the second functionalized polyelectrolyte polymer B at a pressure higher than 1 MPa, wherein the pressure is lower than 100 MPa,
and/or wherein the covalent bond forming step comprises maintaining a contact between first functionalized polyelectrolyte polymer A and the second functionalized polyelectrolyte polymer B for at least 0.5 minutes at said pressure.

48. The method of claim 46, wherein the temperature during the covalent bond forming step is lower than 80° C.

49. The method of claim 46, wherein said functionalized surface of the first substrate and/or of the second substrate is a 1D surface, a 2D surface or a 3D surface provided as any one or more from a dot, a rod, a wire, a sheet, a film, a piece, a volume, a layer, a line, a ribbon and a plate.

50. The method of claim 46, wherein the first functionalized polyelectrolyte polymer A is a first poly-cationic polymer A+ having cationic repeating units; and wherein step d. the forming of the functionalized surface on the first substrate is carried out by applying the first poly-cationic polymer A+ to an exposed surface of the first substrate, or wherein the first functionalized polyelectrolyte polymer A is a first poly-anionic polymer A—having anionic repeating units; and wherein the method further comprises the step of:
h. forming a polyelectrolyte multilayer on an exposed surface of the first substrate, comprising adhering a poly-cationic polymer to said exposed surface of the first substrate and comprising carrying out step d. thereafter by applying the first poly-anionic polymer A—onto said exposed surface of the first substrate.

51. The method of claim 46, wherein the second functionalized polyelectrolyte polymer B is a second poly-cationic polymer B+ having cationic repeating units; and
wherein step e. the forming of the functionalized surface on the second substrate is carried out by applying the second poly-cationic polymer B+ to said exposed surface of the second substrate,
or wherein the second functionalized polyelectrolyte polymer B is a second poly-anionic polymer B—having anionic repeating units; and wherein the method further comprises the step of:
i. forming a polyelectrolyte multilayer on an exposed surface of the second substrate, comprising adhering a poly-cationic polymer to said exposed surface of the second substrate and comprising carrying out step e. thereafter by applying the second poly-anionic polymer B—onto said exposed surface of the second substrate.

52. The method of claim 46, wherein a plurality of the functionalized repeating units G1 of the first functionalized polyelectrolyte polymer A comprises the first functional group comprising the first coupling moiety A1,
and/or wherein the electrolyte repeating units of the first functionalized polyelectrolyte polymer A comprise non-functionalized repeating units E1 having one or more non-functionalized electrolyte groups selected from cationic groups and anionic groups, wherein the number-% of non-functionalized repeating units E1 is in the range of 30% to 99% with respect to all electrolyte repeating units of the first functionalized polyelectrolyte polymer A,
and/or the number-% of non-functionalized repeating units E1 is in the range of 50% to 95% with respect to all electrolyte repeating units,
and/or wherein the number-% of functionalized repeating units G1 is in the range of 1% to 50% with respect to all electrolyte repeating units of the first functionalized polyelectrolyte polymer A,
and/or wherein a plurality of the functionalized repeating units G2 of the second functionalized polyelectrolyte polymer B comprises the second functional group comprising the second coupling moiety B1,
and/or wherein the electrolyte repeating units of the second functionalized polyelectrolyte polymer B comprise non-functionalized repeating units E2 having one or more non-functionalized electrolyte groups selected from cationic groups and anionic groups, wherein the number-% of non-functionalized repeating units E2 is in the range of 30% to 99% with respect to all electrolyte repeating units of the second functionalized polyelectrolyte polymer B, preferably the number-% of non-functionalized repeating units E2 is in the range of 50% to 95% with respect to all electrolyte repeating units,
and/or wherein the number-% of functionalized repeating units G2 is in the range of 1% to 50% with respect to all electrolyte repeating units of the second functionalized polyelectrolyte polymer B,
and/or wherein at least a part of the non-functionalized repeating units E1, E2 of the first functionalized polyelectrolyte polymer A and/or of the second functionalized polyelectrolyte polymer B comprises a linking group, wherein the linking group comprises a (poly)alkylene glycol group having from 1 to 25 alkylene glycol units.

53. The method of claim 46, wherein the first coupling moieties A1 may be selected from any one or more of tetrazine, trans-cyclooctene, maleimide, dibenzocyclooctyne, diazirine, (4-iodoacetyl)aminobenzoate), disuccinimidyl tartrate or bis(2-succinimidooxycarbonyloxy)ethyl)sulfone, azide, SPDP, [4-(psoralen-8-yloxy)]-butyrate, phosphine, 6-(4′-azido-2′-itrophenylamino) hexanoate, biotin,
and/or wherein the first coupling moieties A1 may be selected from any one or more of tetrazine, trans-cyclooctene, maleimide and dibenzocyclooctyne,
and/or wherein the functionalized repeating units G2 of the second functionalized polyelectrolyte polymer B are functionalized by the presence of any one or more second coupling moiety B1 independently selected from a thiol group and an amine, when the first coupling moieties A1 comprises maleimide, a strained alkyne and a strained alkene, such as trans-cyclooctene, when the first coupling moieties A1 comprises tetrazine, tetrazine, when the first coupling moieties A1 comprises trans-cyclooctene, and azide, when the first coupling moieties A1 comprises dibenzocyclooctyne,
and/or wherein the first coupling moieties A1 of the first functional group is a single first coupling moiety A1 selected from tetrazine, trans-cyclooctene, maleimide and dibenzocyclooctyne,
and/or wherein the first coupling moieties A1 of the first functional group is two or more first coupling moieties A1 independently selected from tetrazine, trans-cyclooctene, maleimide and dibenzocyclooctyne,
and/or wherein at least one of the first functionalized polyelectrolyte polymer A and the second functionalized polyelectrolyte polymer B comprises a poly-L-lysine (PLL) segment, preferably wherein both functionalized polyelectrolyte polymers A and B comprise a poly-L-lysine (PLL) segment,
and/or wherein at least one of the first functionalized polyelectrolyte polymer A and the second functionalized polyelectrolyte polymer B additionally comprises one or more other electrolyte repeating units other than a L-lysine repeating unit,
and/or wherein at least a part of the functionalized repeating units G1 of the first functionalized polyelectrolyte polymer A comprises a linking group for bonding the first functional group to the backbone of the corresponding repeating unit,
and/or wherein at least a part of the functionalized repeating units G2 of the second functionalized polyelectrolyte polymer B comprises a linking group for bonding the second functional group to the backbone of the corresponding repeating unit, and/or wherein the linking group comprises a (poly)alkylene glycol group having from 1 to 25 alkylene glycol units, and/or wherein the alkylene group moieties comprise ethylene glycol units.

54. The method of claim 46, wherein the exposed surface of the first substrate and/or the exposed surface of the second substrate is the surface of a material selected from the group of materials comprising a glass, silicon, silicon oxide, silicon/silicon oxide, titanium oxide, a metal oxide, a polymer material, an activated polymer, a cyclic olefin (co) polymer, and a metal,
and/or wherein the exposed surface of the first substrate and/or the exposed surface of the second substrate is the surface of a polymer,
and/or wherein the functionalized surface of the first substrate and the functionalized surface of the second substrate comprise a respective contact part for forming the contact area in the contacting step f.

55. The method of claim 46, wherein at least one of the first substrate and the second substrate additionally comprises a receptor area, which is arranged outside the contact area, for receiving functionalized receptor molecules, and/or wherein the functionalized receptor molecules comprise one or more receptor coupling moieties R1 independently selected from any one or more of tetrazine, trans-cyclooctene, maleimide and dibenzocyclooctyne,
and/or wherein the receptor area is part of the functionalized surface of the first substrate and/or the receptor area is part of the functionalized surface of the second substrate,
and/or wherein the receptor area is formed by attaching a third functionalized polyelectrolyte polymer C to an exposed surface of said first substrate or an exposed surface of said second substrate, respectively, wherein the third functionalized polyelectrolyte polymer R comprises a plurality of electrolyte repeating units, wherein at least one of the electrolyte repeating units is a functionalized repeating unit G3 comprising a third functional group comprising a third coupling moiety C1, wherein the third coupling moiety C1 is selected from tetrazine, trans-cyclooctene, maleimide and dibenzocyclooctyne,
and/or wherein receptor area is located to be exposed to at least one enclosed space of the device selected from a chamber and a channel, which is formed after bonding the first substrate to the second substrate (step g).

56. The method of claim 55, wherein the method comprises at least one further step of:
j. binding functionalized receptor molecules comprising one or more receptor coupling moieties R1 to at least a part of the first coupling moieties A1 attached to the functional area of the functionalized surface of the first substrate;
k. binding functionalized receptor molecules comprising one or more receptor coupling moieties R1 to at least a part of the second coupling moieties B1 attached to the functional area of the functionalized surface of the second substrate;
l. binding functionalized receptor molecules comprising one or more receptor coupling moieties R1 to at least a part of the third coupling moieties C1 attached to the first substrate; and
m. binding functionalized receptor molecules comprising one or more receptor coupling moieties R1 to at least a part of the third coupling moieties C1 attached to the second substrate;
and/or wherein the functionalized receptor molecule is selected from any one or more of an antibody or fragment or derivative thereof such as a Fab, scFv, one or more Vh domains, a nucleotide, a nucleic acid, such as DNA, RNA or PNA, a peptide, a protein, a cell-surface receptor or extra-cellular fragment thereof, a carbohydrate, a lipid, a ligand for an antibody or a cell surface receptor, and complexes, multimers, modified forms thereof, of natural origin and/or of synthetic origin.

57. A device obtainable by the method according to claim 46, wherein the device comprises a first substrate and a second substrate bonded to each other, wherein the first substrate comprises a functionalized surface having the first functionalized polyelectrolyte polymer A attached thereon, wherein the first substrate comprises a functionalized surface having the first functionalized polyelectrolyte polymer A attached thereon, wherein the second substrate comprises a functionalized surface having the second functionalized polyelectrolyte polymer B attached thereon; and wherein the first substrate and a second substrate are bonded to each other at a contact area, which is formed by contacting the first functionalized polyelectrolyte polymer A with the second functionalized polyelectrolyte polymer B; and wherein the first substrate is bonded to the second substrate by covalent bonds formed between first coupling moieties A1 and second coupling moieties B1 in the contact area between the first substrate and the second substrate.

58. The device of claim 57, wherein the device additionally comprises at least one enclosed space selected from a chamber and a channel, wherein a part of functionalized surface of the first substrate is located to be exposed to said enclosed space of the device and/or a part of functionalized surface of the second substrate is located to be exposed to said enclosed space of the device,
and/or wherein said part of the respective functionalized surface is a receptor area functionalized with functionalized receptor molecules, and
and/or wherein the device is a biosensor, and/or wherein the device is a microfluidic device.

59. A use of the device of claim 57, in particular the device being a biosensor or a microfluidic device, for at least one or more of the detection of an analyte, the fabrication or modification of nanoparticles, the formation of droplets, and the synthesizing of chemicals, and/or wherein the functionalized receptor molecule is a DNA probe or a PNA probe and wherein the analyte is a nucleic acid.

60. A microfluidic device comprising:
a. a first substrate comprising a functionalized surface having the first functionalized polyelectrolyte polymer A attached thereon, wherein the first functionalized polyelectrolyte polymer A comprises electrolyte repeating units, wherein at least one of the electrolyte repeating units is a functionalized repeating unit G1 comprising a first functional group comprising a first coupling moiety A1;
b. a second substrate comprising a functionalized surface having the second functionalized polyelectrolyte polymer B attached thereon, wherein the second functionalize polyelectrolyte polymer B comprises electrolyte repeating units, wherein at least one of the electrolyte repeating units is a functionalized repeating unit G2 comprising a second functional group comprising a second coupling moiety B1;
wherein the first substrate and a second substrate are bonded to each other at a contact area, wherein the first functionalized polyelectrolyte polymer A contacts the second functionalized polyelectrolyte polymer B; and wherein covalent bonds are present between first coupling moieties A1 of the first substrate and second coupling moieties B1 of the second substrate.
